(19) United States
(12) Patent Application Publication
(10) Pub. No.: US 2006/0213570 A1
(43) Pub. Date: Sep. 28, 2006

(54) Flexible Stiffner for PEX

(75) Inventor: Emilian Moldovan, Portland, OR (US)

Correspondence Address: EMILIAN MOLDOVAN, 912 NE 174TH AVENUE, PORTLAND, OR, 97230, US

(73) Assignee: Mr. Emilian Moldovan, Portland, OR (US)

(21) Appl. No.: 10/906,840

(22) Filed: Mar. 8, 2005

(51) Int. Cl. F16L 9/14

(52) U.S. Cl. 138/153

(57) ABSTRACT

A stiffener is made of a 9 gauge wire core. Over the length of the core, a 14 gauge wire is wrapped in a spiral shape to complete an assembly that is ⅜ inch diameter. At one end, it has a stopper which prevents the stiffener from being dropped inside the tube. It is 5 feet in length and would be used for ½ inch tubes. For ¾ inch tubes, the exterior diameter of the stiffener is ⅝ inch and multi layers of the wire wrapped around the core, its total length being again 5 feet. For 1 inch tube, the exterior diameter is ⅞ inch. Considering the rigidity of both the ¾ and 1 inch tubes, the stiffener is used only to control the tubes interior shape.

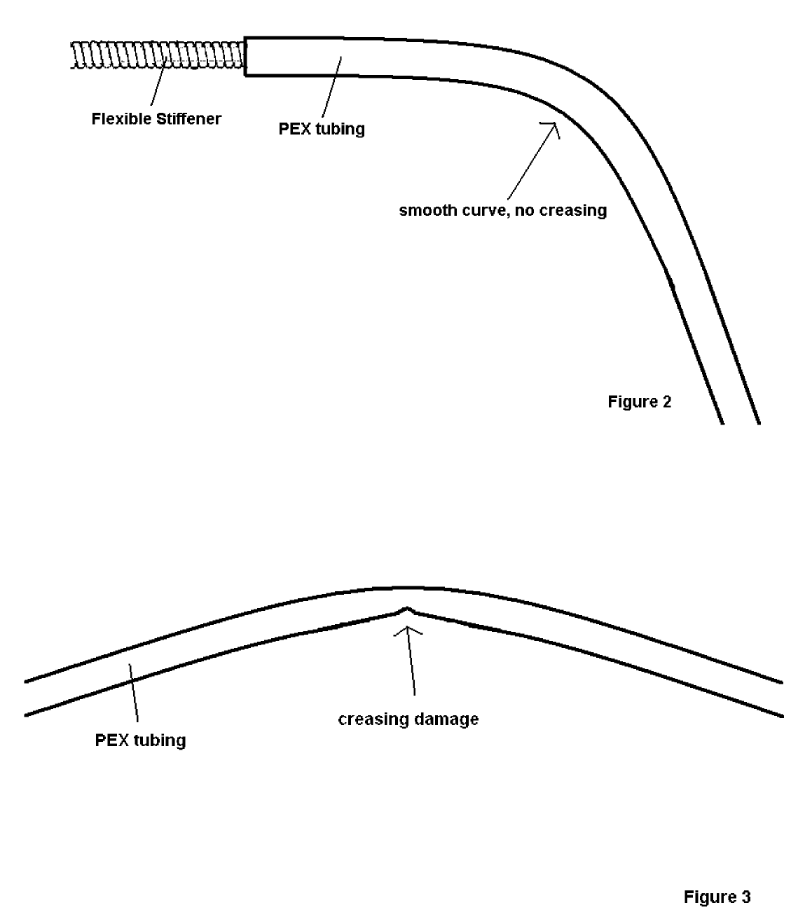

In residential plumbing, PEX tubing is an excellent material, easy to work with and it doesn't require an open flame for assembly as does copper piping. It is known that at the place where it wrinkles, the molecular structure is weakened, and because of the change in temperature and pressure, the tube breaks in that area. To avoid creasing during installation (FIG. 3), a Flexible Stiffener can be introduced in the tube, which has the role to maintain the tube at the normal dimension (shape), and at the same time, to verify the change in direction (FIG. 2). On a curved path, if the radius of the curve is smaller than the one recommended by the manufacturer, the interior of the tube gets blocked inside or hardly moves, indicating that path has remade. At the same time it can be used as a guide for 90 degree or 180 degree curves where an obstacle has to be avoided or bypassed, such as follows:

The curve made is estimated in between two holes. The stiffener is modeled into a curve, and then it is introduced in the two holes. The tube interior is placed on the stiffener, after which the tube is pushed in the holes. The stiffener serves as a guide for the tube.

What is claimed is:

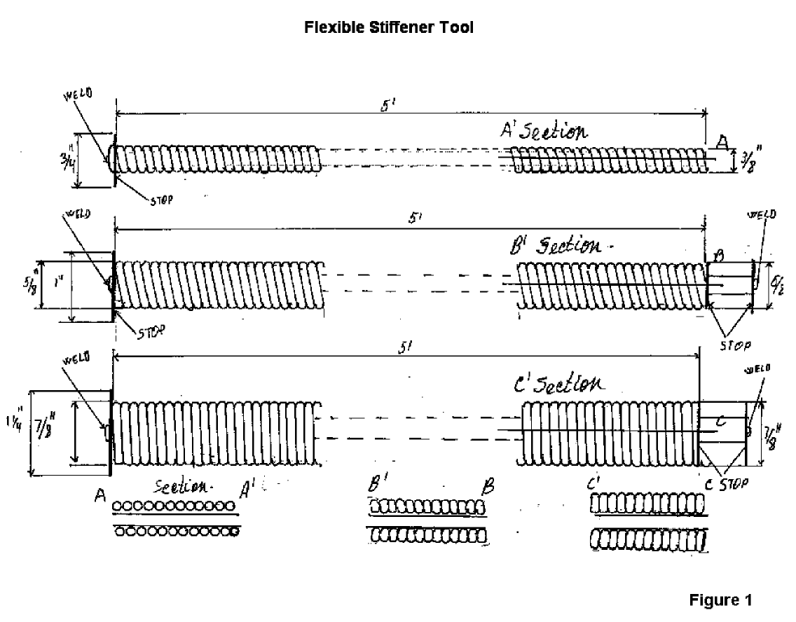

1. A 14 gauge wire is wrapped in a spiral shape around a 5 foot long, 9 gauge wire core to complete an assembly that is ⅜ inch diameter. See section ‘A’ of FIG. 1.

2. The assembly of claim 1, with multiple layers of the wire wrapped around the 9 gauge core for ⅝ inch thickness. See section ‘B’ of FIG. 1.

3. The assembly of claim 1, with multiple layers of the wire wrapped around the 9 gauge core for ⅞ inch thikness. See section ‘C’ of FIG. 1.

4. The assembly of claim 1, 2, and 3 made of plastic material.

5. The process of installing PEX tubing with Flexible Stiffener as to prevent damage and creasing. Insert Flexible Stiffener tool through the holes where PEX is to be installed. Once Flexible Stiffener tool is in place, insert PEX tubing over Flexible Stiffener tool until it travels through desired area. Remove Flexible Stiffener tool from inside the PEX tubing. PEX tubing is now properly installed in desired area without being damaged.
